(19) United States
(12) Patent Application Publication
(10) Pub. No.: US 2025/0166055 A1
(43) Pub. Date: May 22, 2025

(54) COMPUTER IMPLEMENTED SYSTEM AND METHOD OF FACILITATING THE BORROWING OR HIRING OF EQUIPMENT

(71) Applicants: MAGPIE ENTERPRISES PTY LTD, Docklands, Victoria (AU); ALJO GROUP PTY LTD, Richmond, Victoria (AU)

(72) Inventors: Beradino Anthony TARQUINI, Kew, Victoria (AU); David OWEN, Melbourne, Victoria (AU)

(21) Appl. No.: 18/840,300

(22) PCT Filed: Feb. 21, 2023
(86) PCT No.: PCT/AU2023/050113

§ 371 Date: Aug. 21, 2024

(30) Foreign Application Priority Data
Feb. 21, 2022 (AU) 2022900381

(51) Int. Cl. G06Q 30/0645; G06Q 30/018

(52) U.S. Cl. CPC G06Q 30/0645; G06Q 30/018

(57) ABSTRACT

The present invention relates to a system and method of facilitating the borrowing or hiring of equipment. including receiving details relating to one or more potential borrowers or hirers of equipment (including at least a location of each of the one or more potential borrowers or hirers), receiving details regarding each piece of equipment available for loan or hire (including information relating to the entity responsible for providing equipment for loan or hire including a pickup location of the equipment, a description relating to the equipment including a description regarding the condition of the equipment, and an image of the equipment), storing the equipment details in an equipment database including a data structure. providing a search facility that enables a potential borrower or hirer to search the data structure using a key word search such that the search request generates results filtered according to equipment available within a predetermined vicinity of the potential borrower or hirer, providing an interactive interface that enables viewing

of the details regarding equipment selected by the potential borrower or hirer (with the ability to confirm their selection and thereby establish a borrowing or hiring arrangement), and providing access to data communication links with one or more insurance providers to enable the provision of insurance cover with respect to the borrowing or hiring arrangement.

### FIELD OF THE INVENTION

The present invention relates to a system and method of facilitating the borrowing or hiring of equipment. In particular, the present invention enables users seeking to borrow or hire equipment to determine the availability of equipment from other users (eg. the owners of the equipment) quickly and efficiently and establish agreements with those users. The agreements seek to protect the borrower/hirer in the event of any damage or failure regarding proper operation of the equipment, as well as the owner of the equipment in the event of return of equipment in a degraded condition as compared with the condition of the equipment at the time the equipment was borrowed or hired.

### BACKGROUND OF THE INVENTION

In recent years, there has been an increasing interest in the sharing economy and collaborative consumption which enables shared use of goods and assets that otherwise must be purchased by individuals. An example of collaborative consumption is the hiring and borrowing of equipment (eg. for construction, gardening, etc.). The “hiring” of such equipment typically involves a user agreeing to take possession of a piece of equipment for an agreed period of time in exchange for compensation to the owner of the equipment. The “borrowing” of such equipment involves a similar exchange, although the user who owns the equipment agrees to lend the equipment to another user without compensation.

Managing equipment and bookings for equipment hire/borrow is a time consuming and predominantly manual process consisting of various spreadsheets, calendars and maintenance schedules. An error in any one of these processes can lead to a break down in the booking process and the loss of valuable time and money whilst errors are corrected. Furthermore, equipment availability recorded via manual methods are typically difficult to track which can result in double bookings and disgruntled customers. There is therefore a need for a more efficient and seamless solution to the problem of managing the borrowing or hiring of equipment.

A borrower or hirer of equipment will typically seek equipment that will operate properly and in accordance with reasonable expectations, and the owner of the equipment (or an entity acting on their behalf) will expect that the equipment is returned in substantially the same condition and not in a degraded or damaged state apart from normal wear and tear. To address such occurrences, each party will typically seek to establish an insurance policy in respect of each individual piece of equipment that ensures compensation is provided to the borrower/hirer in the event the equipment fails to meet reasonable operating expectations, and to the entity providing the equipment for borrowing/hiring in the event the equipment is stolen or returned in a degraded or damaged condition. This process typically requires the verification of each user, and verification regarding the state of the equipment. For example, borrowers or hirers of equipment will require confirmation that the equipment is in good condition and has been maintained on a regular basis.

Accordingly, the process of establishing such agreements is typically time consuming and inefficient and tends to involve substantial computer resource usage (processor, network and memory resources) in the process of searching for an insurance provider, researching and selecting the most appropriate cover, completing various verification steps and ultimately engaging the insurance provider. As a result of these inefficiencies, some individuals elect not to obtain insurance cover which places them at financial risk.

Accordingly, there exists a need for a system and method that addresses, or at least ameliorates, some of the abovementioned problems.

The reference to any prior art in this specification is not, and should not be taken as, an acknowledgement or any suggestion, that the prior art forms part of the common general knowledge.

### SUMMARY OF THE INVENTION

In one aspect, the present invention provides computer-implemented method of facilitating the borrowing or hiring of equipment, the method including receiving, by one or more processors, details relating to one or more potential borrowers or hirers of equipment, the details including at least a location of each of the one or more potential borrowers or hirers receiving, by one or more processors, details regarding each piece of equipment available for loan or hire, the details including information relating to the entity responsible for providing the piece of equipment for loan or hire including a pickup location of the piece of equipment, a description relating to the piece of equipment including a description regarding the condition of the piece of equipment, and an image of the piece of equipment, verifying, by one or more processors, the details regarding each piece of equipment available for loan or hire by verifying the description regarding the condition of the equipment, including verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image against one or more images of the equipment in a new state, storing, by one or more processors, the verified equipment details in an equipment database including a data structure that identifies relationships between each piece of equipment and stored details relating to same, providing, by one or more processors, a search facility that enables a potential borrower or hirer to utilize a data communications device to search the data structure for a piece of equipment using a key word search, the search facility utilizing a key word search algorithm incorporated with a geographical restriction such that any search request submitted by a potential borrower or hirer generates results retrieved using the data structure and filtered according to the pickup location of the piece of equipment residing within a predetermined vicinity of the location of the potential borrower or hirer, and providing, by one or more processors, an interactive interface that enables, the potential borrower or hirer to view the verified details regarding equipment selected by the potential borrower or hirer from the generated search results, the potential borrower or hirer to confirm their selection of the equipment to borrow or hire and thereby establish a borrowing or hiring arrangement with the entity responsible for providing the piece of equipment, and the potential borrower or hirer and/or the entity responsible for providing the equipment for loan or hire to access data communication links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

In an embodiment, the method further includes utilizing a central server to communicate with data communication devices associated with each of the potential borrower or hirer and each of the entities responsible for providing the equipment for loan or hire, whereby each device is operable to execute a software application that enables communication with the central server.

In an embodiment, the location of the potential borrower or hirer is a registered address of the potential borrower or hirer, a current location of the potential borrower or hirer, or a preferred address of the potential borrower or hirer (ie. an address other than the registered address which has been selected by the potential borrower or hirer).

In an embodiment, the current location of the potential borrower or hirer is determined in substantially real-time by utilizing one or more of GPS functionality, Wi-Fi functionality, Cell ID, and/or A-GPS (Assisted GPS) functionality such that any search submitted has improved prospects of locating equipment that is within a convenient distance for the user to access.

Accordingly, by utilizing a geographical restriction during search result generation (e.g. by using geo-fencing functionality), the search submitted by a potential borrower or hirer has their search restricted to their local vicinity to avoid the search analysis providing results that are inappropriate due to long distances between the location of the potential borrower or hirer and the entity responsible for providing the piece of equipment for loan or hire.

Furthermore, by providing data communication links with one or more insurance providers, the potential borrower or hirer is quickly and seamlessly covered for any damage or failure regarding proper operation of the equipment, and the entity responsible for providing the equipment is quickly and efficiently covered against stolen equipment or return of equipment in a degraded or damaged condition.

In an embodiment, the details regarding each piece of equipment further includes one or more of, an identifier associated with the equipment (e.g. serial number), and a make and/or model of the equipment.

In an embodiment, the description relating to each piece of equipment further includes one or more of, a hiring rate set by the user responsible for providing the equipment for hire, including a different hiring rate based on different periods of time for which the equipment will be hired, and penalty costs applicable in respect of failure to return equipment either in acceptable condition or within terms of the borrowing or hiring arrangement.

In an embodiment, the piece of equipment is categorized according to its attributes and/or use and the hiring rate is based upon the categorization of the equipment.

In an embodiment, the use of a piece of equipment is categorized as either residential or commercial, and different hiring rates apply in respect of commercial and residential arrangements based on the different uses of the equipment.

In an embodiment, verifying, by one or more processors, details regarding each piece of equipment further includes verifying one or more of, the description relating to the equipment by comparing the description against a database of existing equipment to determine any errors or inaccuracies with respect to the description (e.g. verifying each equipment by comparing the identifier associated with the equipment with a database of registered serial numbers associated with the particular make and/or model of the equipment), or the identifier associated with the equipment by comparing the identifier with a database of registered serial numbers associated with a particular make and/or model of the equipment.

In an embodiment, the details relating to one or more potential borrowers or hirers of equipment include a minimum amount of identification requested at the time the borrower or hirer establishes a user account.

In an embodiment, the minimum amount of identification includes a driver's license and/or passport of the borrower or hirer.

In an embodiment, the method further includes conducting, by one or more processors, one or more security analyses regarding each potential borrower or hirer, including, an analysis at the time the borrower or hirer seeks to establish the user account and at one or more intervals thereafter.

In an embodiment, the security analyses include checking, by one or more processors, the existence of a police record associated with the potential borrower or hirer.

In an embodiment, the interactive interface further enables one or more of, a calendar functionality that allows potential borrowers or hirers to select available dates for the borrowing or hiring of a particular piece of equipment, a payment gateway that allows potential hirers to make a payment in relation to hiring a selected equipment for a selected period of time, provision of instructional material including documents (e.g. manuals) and media (e.g. photos, videos, etc) to assist the borrower or hirer regarding correct operation of the piece of equipment, or a communication gateway that allows for communication between users seeking to establish a borrowing or hiring arrangement (e.g. chat functionality that enables the exchange of messages regarding the status and/or availability of equipment).

According to another aspect, the present invention provides a system that facilitates the borrowing or hiring of equipment, the system including one or more processors that receive details relating to one or more potential borrowers or hirers of equipment, the details including at least a location of each of the one or more potential borrowers or hirers, receive details regarding each piece of equipment available for loan or hire, the details including information relating to the entity responsible for providing the piece of equipment for loan or hire including a pickup location of the piece of equipment, a description relating to the piece of equipment including a description regarding the condition of the piece of equipment, and an image of the piece of equipment, verify, by one or more processors, the details regarding each piece of equipment available for loan or hire by verifying the description regarding the condition of the equipment, including verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image with one or more images of the equipment in a new state, store the verified equipment details in an equipment database that includes a data structure that identifies relationships between each piece of equipment and stored details relating to same, provide a search facility enabling a potential borrower or hirer to utilize a data communications device to search the data structure for a piece of equipment using a key word search, the search facility utilizing a key word search algorithm incorporated with a geographical restriction such that any search request submitted by a potential borrower or hirer generates results retrieved using the data structure and filtered according to the pickup location of the piece of equipment residing within a predetermined vicinity of the registered location of the potential borrower or hirer, provide an interactive interface that enables the potential borrower or hirer to view the verified details regarding equipment selected by the potential borrower or hirer from the generated search results, the potential borrower or hirer to confirm their selection of the equipment to borrow or hire and thereby establish a borrowing or hiring arrangement with the entity responsible for providing the piece of equipment, and the potential borrower or hirer and/or the entity responsible for providing the equipment for loan or hire to access data communication links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

According to a further aspect, the present invention provides a non-transient computer-readable medium including computer instruction code that, when executed on a computer, causes one or more computer processors of the computer to perform steps to facilitate the borrowing or hiring of equipment, including receiving details relating to one or more potential borrowers or hirers of equipment, the details including at least a location of each of the one or more potential borrowers or hirers, receiving details regarding each piece of equipment available for loan or hire, the details including information relating to the entity responsible for providing the piece of equipment for loan or hire including a pickup location of the piece of equipment, a description relating to the piece of equipment including a description regarding the condition of the piece of equipment, and an image of the piece of equipment, verifying, by one or more processors, the details regarding each piece of equipment available for loan or hire by verifying the description regarding the condition of the equipment, including verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image with one or more images of the equipment in a new state, storing the verified equipment details in an equipment database that includes a data structure that identifies relationships between each piece of equipment and stored details relating to same, providing a search facility enabling a potential borrower or hirer to utilize a data communications device to search the data structure for a piece of equipment using a key word search, the search facility utilizing a key word search algorithm incorporated with a geographical restriction such that any search request submitted by a potential borrower or hirer generates results retrieved using the data structure and filtered according to the pickup location of the piece of equipment residing within a predetermined vicinity of the registered location of the potential borrower or hirer, providing an interactive interface that enables the potential borrower or hirer to view the verified details regarding equipment selected by the potential borrower or hirer from the generated search results, the potential borrower or hirer to confirm their selection of the equipment to borrow or hire and thereby establish a borrowing or hiring arrangement with the entity responsible for providing the piece of equipment, and the potential borrower or hirer and/or the entity responsible for providing the equipment for loan or hire to access data communication links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

According to yet a further aspect, the present invention provides a portable electronic device for use by a potential borrower or hirer of equipment, the device including a database including a data structure for storing indexed details relating to a plurality of pieces of equipment available for loan or hire, the details including information relating to an entity responsible for providing each piece of equipment for loan or hire including a pickup location of the piece of equipment, a description relating to the equipment including a description regarding the condition of the piece of equipment, and an image of the piece of equipment, wherein the equipment details are verified based on verifying the description regarding the condition of the equipment, including verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image with one or more images of the equipment in a new state, a touch screen configured to receive an input corresponding to a touch operation of the potential borrower or hirer of equipment on an area of the touch screen, and a processor connected to the touch screen, wherein the processor is configured to detect the input to the touch screen and perform operations including detecting a first input, via the touch screen, of details relating to the potential borrower or hirer of equipment, including a location of the potential borrower or hirer, providing a search facility for display on the touch screen enabling the potential borrower or hirer to utilize the touch screen to search the data structure for a piece of equipment using a key word search, the search facility utilizing a key word search algorithm incorporated with a geographical restriction such that any search request submitted by the potential borrower or hirer generates results retrieved using the data structure for display on the touch screen and filtered according to the pickup location of the piece of equipment residing within a predetermined vicinity of the location of the potential borrower or hirer, detecting a second input, via the touch screen, of a selection by the potential borrower or hirer of equipment of a piece of equipment from the displayed results, detecting a third input, via the touch screen, reflecting confirmation regarding selection of the piece of equipment by the potential borrower or hirer of equipment and thereby establishing a borrowing or hiring arrangement with the entity responsible for providing the piece of equipment, and providing, for display on the touch screen, data communications links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components;

FIG. 2 illustrates an exemplary diagram associated with the server component within the system illustrated in FIG. 1;

FIG. 3 illustrates an exemplary flow diagram of a process that enables a user seeking to borrow or hire equipment to download and install a software application, and subsequently access, or register to use, the software application, for interaction with the system illustrated in FIG. 1;

FIG. 4 illustrates an exemplary flow diagram of a process that enables a user seeking to lend or hire out equipment to use a dedicated version of the software application to access, or register to use, the software application for interaction with the system illustrated in FIG. 1, including to upload details relating to the equipment;

FIG. 5 illustrates an exemplary diagram associated with an example interface of the software application utilized by users seeking to borrow or hire equipment for the purpose of searching for equipment and scheduling the hiring or borrowing of same for a particular time period according to the system illustrated in FIG. 1;

FIG. 6 illustrates an exemplary diagram associated with an example interface of each software application including a security verification interface for equipment and user verification according to the system illustrated in FIG. 1;

FIG. 7 illustrates an exemplary diagram associated with example interfaces of each software application to enable interaction and communication with insurance providers according to the system illustrated in FIG. 1; and

FIG. 8 illustrates an exemplary diagram associated with an example interface of each software application in the form of an alerts/notifications interface according to the system illustrated in FIG. 1.

### DETAILED DESCRIPTION OF EMBODIMENT(S) OF THE INVENTION

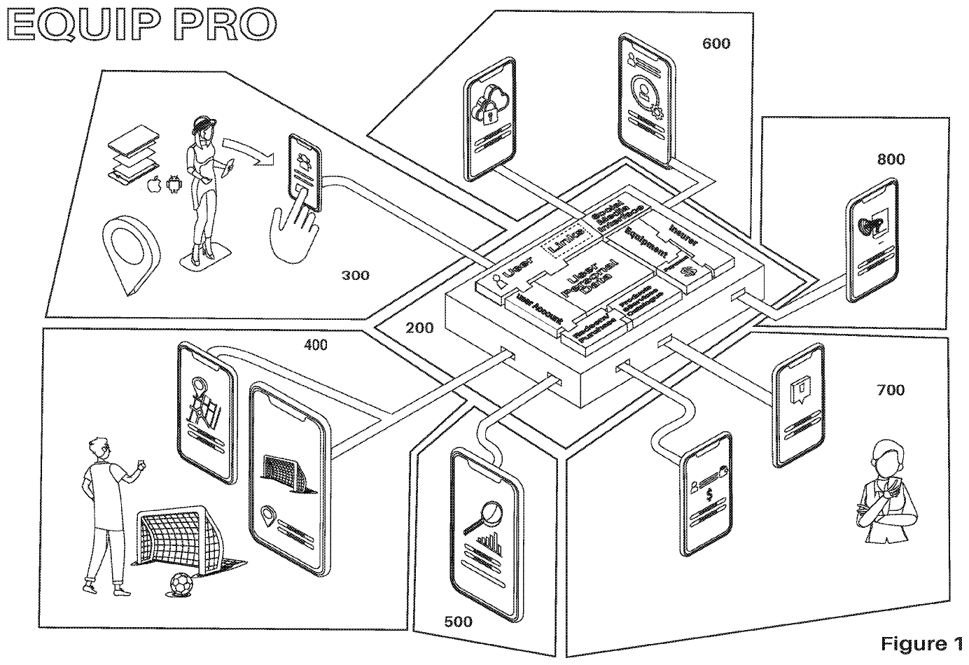

The present invention, according to an embodiment, relates to a system and method of facilitating the borrowing or hiring of equipment, involving a first group of users (30) who seek to borrow or hire equipment (85), and a second group of users (60) who seek to loan equipment or to make equipment available for hire to other individuals, as depicted in FIG. 1. The system and method provide a platform that hosts a computer-executable software application having different functionality depending upon the user of the application (eg. application (40) for users (30) seeking to borrow or hire equipment, and application (70) for users (60) seeking to make equipment available for loan or hire). The platform enables the generation of search results (220) after a user (30) has searched an equipment database (110) using a key word search, the search results representing a selected subset of equipment that is available within a pre-determined vicinity of a location of the potential borrower or hirer (30), for viewing and selection by the user (30).

In this way, the potential borrower or hirer (30) is provided with an interactive interface that enables viewing of the details regarding equipment selected from the generated search results and the ability to confirm their selection, thereby establishing a borrowing or hiring arrangement with a user (60) responsible for providing the piece of equipment (85). The interactive interface (220) further provides data communication links with one or more insurance providers (98) to facilitate obtaining insurance cover with respect to the borrowing or hiring arrangement.

The platform is provided by a central server (20) which maintains one or more processors and/or databases for performing functions, including receiving details from users (30) seeking to borrow or hire equipment, including at least their location (80), and receiving details from users (60) seeking to make a piece of equipment (85) available for borrowing or hiring, including details regarding the piece of equipment (85) such as a pick up location (90) for the equipment (85), a condition of the equipment, and an image (95) of the equipment. The received details may be subsequently verified using security verification functionality (130) associated with server (120) such that the authenticity of details presented by each user may be verified against public and/or private third party data, as described in greater detail below.

The server (20) may subsequently receive requests from users (30) to search for equipment available for borrowing or hiring (eg using a keyboard search). Based upon processing the search request (along with additional received details) using search engine (140) associated with server (20) (eg. using a geographical restriction algorithm), search results (220) may be generated reflecting a selected subset of all of the available equipment in database (110). Such results may subsequently be displayed (220) to the user (30) to enable the user (30) to select a particular piece of equipment (85) for further viewing and ultimately selection, and to receive a prompt regarding the availability of an insurance provider (98) to provide insurance cover with respect to the borrowing or hiring arrangement.

The person skilled in the relevant field of technology will appreciate that the platform provides a solution to existing problems associated with the borrowing or hiring of equipment since, by enabling such steps to be performed in a computer-implemented environment using server (20), users (30) are provided with the ability to quickly and efficiently locate equipment for borrowing or hiring. Conversely, users (60) who have equipment to loan or hire to other individuals are provided with the ability to quickly and efficiently list their equipment on an online marketplace. By utilizing a geographical restriction during search result generation the search submitted by a potential borrower or hirer (30) has their search grammatically restricted by their local vicinity to prevent the search analysis providing results that are inappropriate due to long distances between the location of the user (30) and the entity (60) responsible for providing the equipment for loan or hire.

Furthermore, by providing data communication links to one or more insurance providers, the potential borrower or hirer (30) may efficiently establish insurance coverage for any damage or failure regarding operation of the equipment. The software application (70) associated with the user (60) providing the piece of equipment for loan or hire may similarly be presented with links to one or more insurance providers enabling the user (60) to quickly and efficiently consider insurance cover against, for example, damage to the equipment, return of the equipment in a degraded condition or failure to return the equipment.

In view of the above practical and useful results that arise from the described implementation of the present invention, the use of a data communications device (50) on which the software applications (40/70) are operated in a particular manner represents improved use of computing technology.

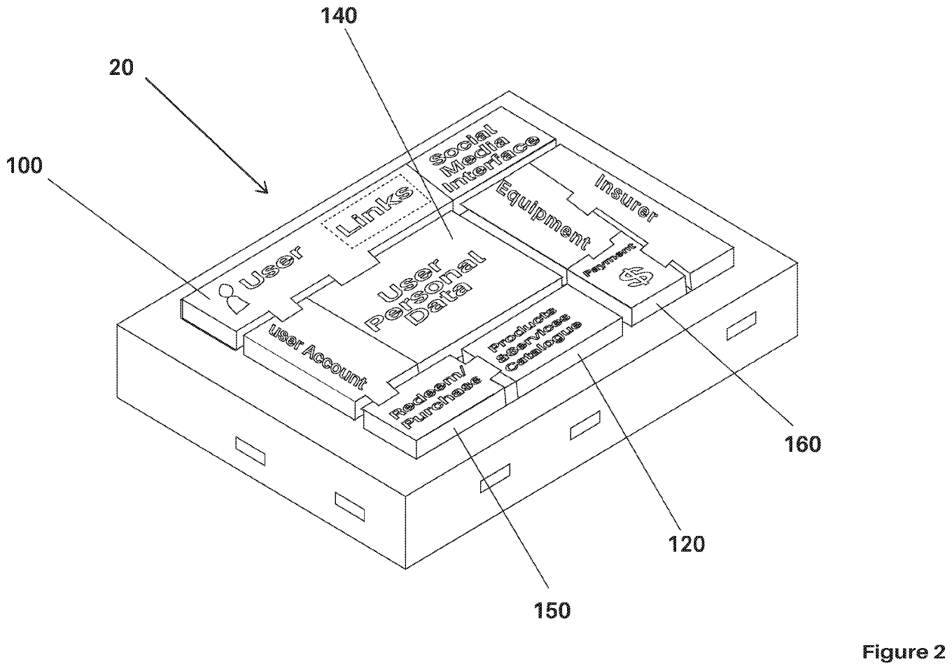

FIG. 1 is divided into segments which are further expanded in subsequent FIGS. 2 to 8. In particular, segment 200 of FIG. 1 shows the server component (20) with which software application (40) operating on data communication devices (50) of users (30) are configured to communicate, and, with which software application (70) operating on data communication devices (50) of users (60) are configured to communicate. It will be apparent to the person skilled in the relevant field of technology that the software applications (40/70) may be mobile applications or web applications, and similarly, the data communication devices (50) utilized by each individual (30) and (60) may be portable devices or fixed location computing devices. Examples of portable devices include mobile phones, laptops and computer tablets, and examples of computer devices include workstations and personal computers. In the embodiments shown, the device (50) is a mobile phone device.

The server component (20) is additionally detailed in FIG. 2 and the skilled person will appreciate that the steps described herein, may be executed by the devices (50), wherein such operations are facilitated by the software applications (40/70) operating on each device (50). According to another implementation, the server (20) may be programmed to provide all or most of the processing functions described herein, where they cannot be provided locally on the user devices (50) or where it may be commercially or technically impractical to implement such arrangements.

In other words, the steps described herein as performed by the user devices (50) or components thereof, may be associated with hardware that is located externally of the devices (50) such as the remote central server (20) for example (i.e. in a distributed architecture). Different arrangements are possible in this regard and alternate variations will be apparent to the person skilled in the relevant field of technology.

Segment 300 of FIG. 1 shows how the server (20) may be configured for communication with the devices (50) associated with users (30), and segment 400 of FIG. 1 shows how the server (20) may be configured for communication with the devices (50) associated with users (60). In one example, the server (20) may receive data from the devices (50) for the purpose of creating a user and/or equipment profile, e.g. based upon the entry of user details from users (30) and (60) and based upon the entry of user details from users (60) in relation to each piece of equipment (85) that is being listed for borrowing or renting. Segment 300 of FIG. 1 further shows a user (30) downloading and installing the application (40) and subsequently accessing the application (40) to establish an account and profile. It will be understood that user (60) may download and install the application (70) and subsequently access the application (70) in a similar manner.

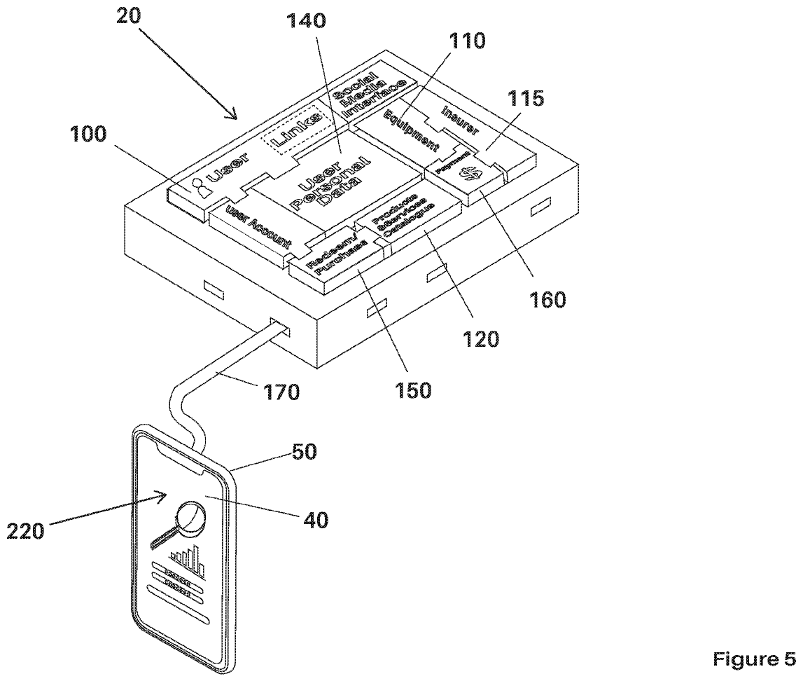

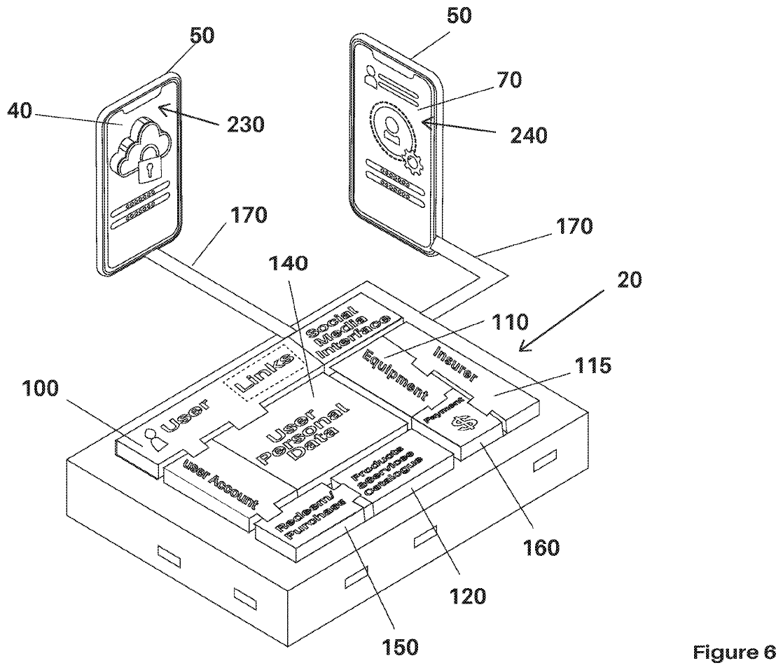

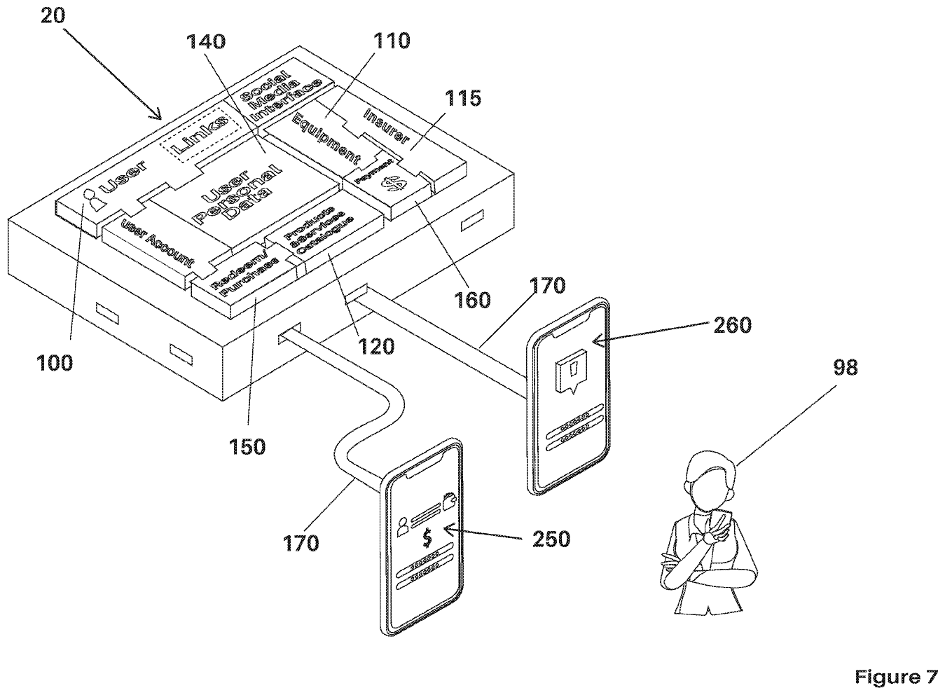

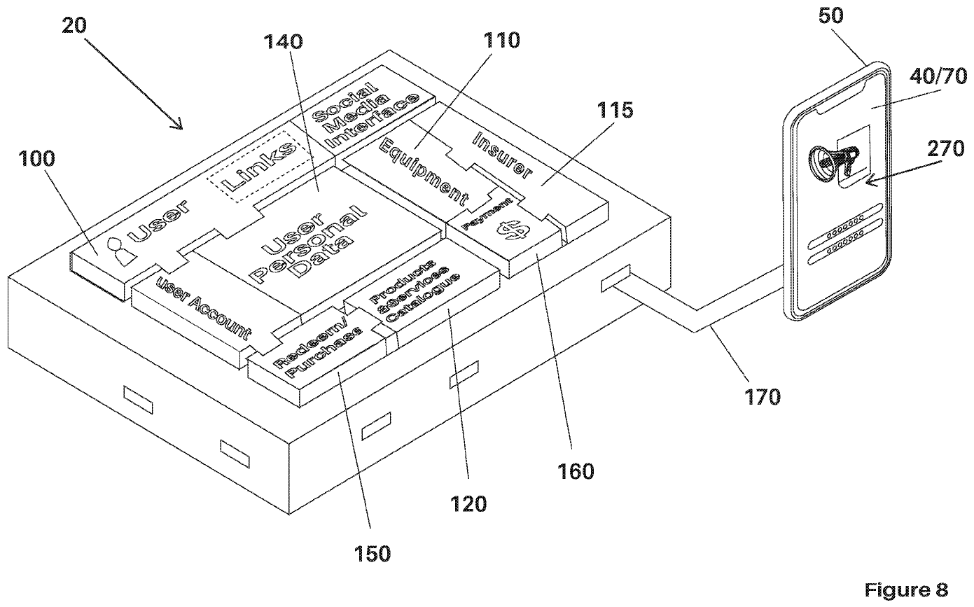

Segment 500 of FIG. 1 shows an example interface (220) in which generated equipment search results and associated information (including data communication links with one or more insurance providers (98)) are presented to the user (30), as further detailed in FIG. 5. Segment 600 of FIG. 1 shows example interfaces (230) and (240) enabling the verification of user and equipment details submitted by the users (30) and (60) respectively, as further detailed in FIG. 6. Segment 700 of FIG. 1 show example interfaces (250) and (260) associated with the software applications (40/70) that enable communication with insurance providers (98) who may provide insurance cover to users (30) and/or (60), as further detailed in FIG. 7. Finally, Segment 800 of FIG. 1 shows an additional example interface (270) providing alerts and/or notifications to users (30) and (60), as further detailed in FIG. 8.

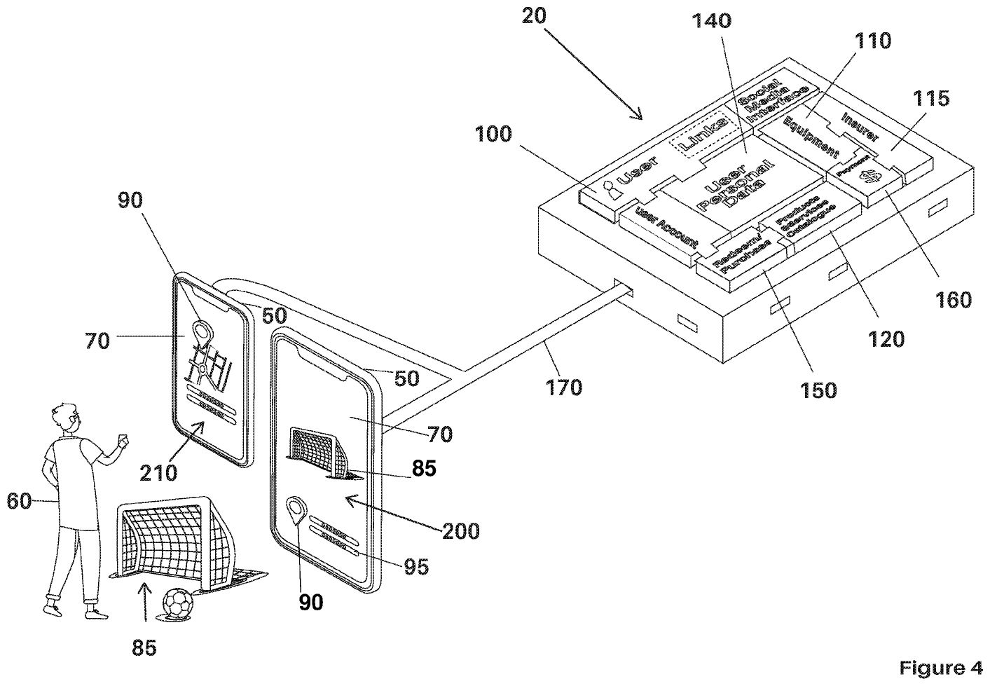

As mentioned above, FIG. 2 shows in greater detail components in Segment 200 of FIG. 1. In particular, FIG. 2 shows the server component (20) which includes infrastructure upon which the platform of the present invention operates. The infrastructure may be local or cloud-based. The central server may operate one or more computer processors and maintain one or more databases to enable the following functionality and/or storage:
User account register (100) storing details relating to both sets of users (30) and (60) (e.g. name, address, contact details, any additional detail which may be relevant for the purpose of identifying each user). Additional details which may be stored in the user account database (100) include details relating to the relationship between users (30) and (60), i.e. details relating to any established borrowing or hiring arrangements between one or more registered users;
Equipment database (110) storing details relating to equipment (e.g. the set of miniature goals (85) shown in FIG. 4) listed by users (60) for the purpose of loaning or hiring out the equipment (85) to other users (30) for an agreed period of time and (in the case of hire) an agreed price. The data stored in equipment database (110) may include the location (90) of the equipment, an identifier (e.g. serial number) with respect to the equipment, a make and/or model of the equipment, a hire cost defined by the user (60), and a description (95) relating to the equipment (85) which may include a description regarding a current condition of the equipment as well as any images and/or videos of the equipment that have been uploaded by user (60) Data stored in equipment database (110) may be approximately indexed using a data structure that identifies relationships between equipment (85) and stored details relating to individual pieces of equipment to facilitate fast and efficient retrieval thereof including when interrogating the database based on a search query;
Insurance provider database (115) storing details relating to insurance providers (98) who have registered to provide services to users of the platform for the purpose of providing insurance cover with respect to borrowing or hiring arrangements between users. The data stored in the insurance provider database (115) may further include communication links to such insurance providers, which may be displayed to users (30) to enable the users (30) to quickly and efficiently connect with an appropriate insurance provider at the time of selecting a piece of equipment for borrowing or hiring. This database (115) may further store details relating to any arrangements which have been agreed between the users (30/60) and the insurance providers (98), including any agreements relating to insurance cover;
Calendar functionality (120) which allows users (30) to select available dates for borrowing or hiring of equipment (85), the calendar functionality (120) accessible to users (30) (e.g. in interface (220)) and which may be configured to interface with a calendar associated with users (60) with respect to the availability of their equipment (85) for borrowing or hiring;
Security verification functionality (130) which enables the authenticity of details presented by each user (30/60) to be verified and for the verification results to be reported to relevant users, as depicted in FIG. 6. For example, users (30) may seek verification of the description provided by users (60) relating to equipment (85) as submitted by users (60) by comparing same against a database of existing equipment and determining any errors which may exist with respect to the description relating to the equipment (85) (e.g. by comparing a serial number associated with the equipment with a database of registered serial numbers associated with the particular make and/or model of the equipment (85)). The security verification functionality (130) may further utilize one or more artificial intelligence techniques to compare the description regarding the equipment with other data uploaded to the platform including, for example, an image of the equipment or with one or more external databases. Likewise, users (60) may seek verification regarding the details provided by users (30) including checking for the existence of a police record associated with a potential borrower or hirer of the equipment;
Search engine functionality (140) which may utilize intelligent algorithms and/or machine learning (e.g. a key word search engine incorporated with a geographical restriction algorithm) to process the equipment search requests from users (30) in order to generate and display to the users (30) a subset of the available equipment that satisfies, to a predetermined standard or similar threshold, the location of the user (30), as described in greater detail below;
Shopping cart database (150) which temporarily stores data relating to equipment selected by users (30) for potential borrowing or hiring but which is yet to be confirmed for borrowing or wiring by the user (30), whereby such data may be saved such that when the user (30) exits the application and then accesses the application (40) again, the shopping cart will continue to indicate previously selected equipment; and
Payment gateway (160) which enables the generation of invoices in respect of an equipment hiring arrangement, including based on confirmation of hiring equipment present in the user's shopping cart, and which enables users (30) to attend to an electronic payment of the relevant invoice(s) (e.g. by any known electronic payment method including credit card, PayPal, EFT, etc.).

Server (20) may further include any relevant communications functionality which captures and stores communication between users, as well as communications with insurance providers, which have occurred via the relevant software application (40/70).

In this regard, FIG. 2 also depicts that server (20) is configured to enable communication (170/175) with the devices (50) and, in particular, the software applications (40/70) operating on each device (50) associated with each user (30) and (60). Such communications may occur via the internet or similar network.

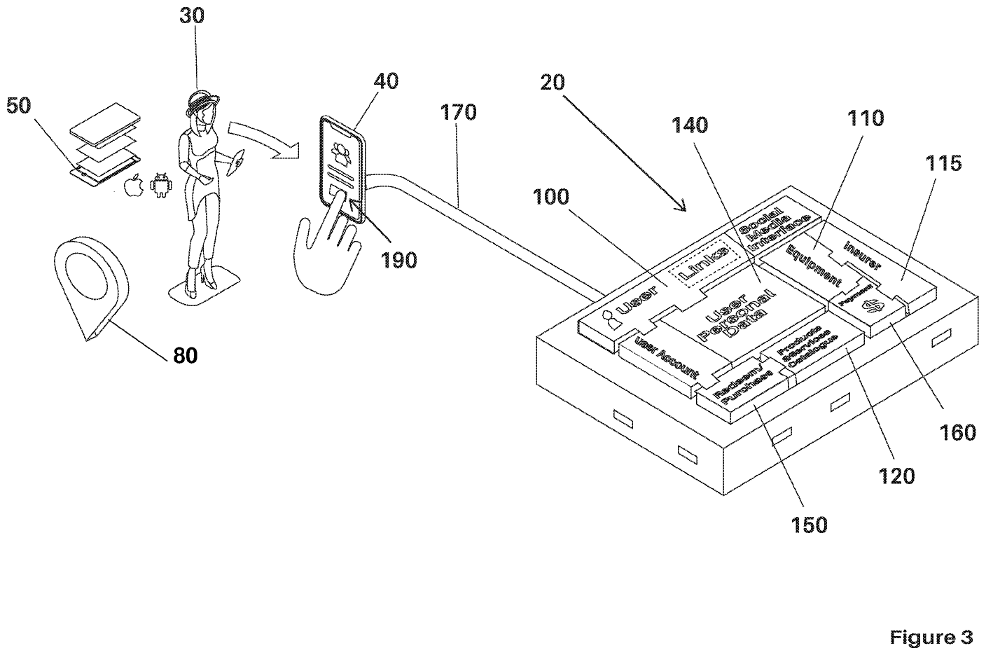

FIG. 3 shows in greater detail the various components depicted in segment 300 of FIG. 1 and, in particular, the steps associated with user (30) installing (180) the software application (40) on their device (50), and subsequently accessing a user login and registration interface (190) associated with the application (40). Such access may be granted after the user (30) has installed the application (40) which may be achieved by downloading the application (40) from an application store. Each user (30) may create an account (which may include a user profile) using the application (40), and the account/profile information may be stored in the user account database (100). A similar process may occur with respect to users (60) who may similarly install their dedicated software application (70), and create an account which may not only include a user profile but which may also include a profile for equipment listed by the user (60). Such information may also be stored in the equipment account database (110).

Once each user (30/60) has accessed their respective application (40/70), each user (30/60) may be presented with a further interface (190/200) that allows the user (30/60) to create and maintain their respective profiles (including the abovementioned equipment profile on behalf of users (60)) that will subsequently enable other users to view information about the users (30/60), and allow users (30/60) to manage their profiles. For example, user (30) may create a user profile, and user (60) may create a user profile as well as a profile for any equipment (85) which he/she prefers to list as being available for borrowing or hiring. Such details may be made available to other registered users via the respective software applications (40/70).

The user profiles may contain basic information about each user (30/60) as described above, including name, age, location etc. and over time, the user profiles may include additional information such as historical data relating to borrowing or hiring history, ratings provided by other users etc. The equipment profiles may contain uploaded information and any uploaded media (photos, videos, etc) relating to the equipment (85), as well as any relevant links such as links to instructional material, etc.

Also shown in FIG. 3 is the location (80) of the user (30) seeking to borrow or hire a particular piece of equipment (85). The location (80) of the potential borrower or hirer (30) is an address that has been registered by the user (30) and may be, for example, a home address of the user (30), a current location of the user (30), or to a preferred address of the user (30) (eg. an address which the user (30) selects which is different to their home or current address). Where the address is a current location of the user (30), such location may be determined in substantially real time by using GPS functionality, WiFi functionality, cell ID or GPS functionality associated with the user device (50). In this way, any search submitted by the user (30) has improved prospects of locating equipment (85) that is within a convenient distance of the user (30).

FIG. 4 shows in greater detail the components depicted in segment 400 of FIG. 1 and, in particular, the steps associated with user (60) uploading information relating to a piece of equipment (85) which the user (60) prefers to list as available for borrowing or hiring. In addition to specifying information relating to the entity responsible for providing the equipment (85) including a registered pick up location, and a description in relation to the condition of the equipment which may include an image of the equipment, the details submitted by user (60) in interface (200) may further include an identifier associated with the equipment (e.g. a serial number, or a make and/or model of the equipment). Such equipment details, files, etc, may be stored in a data structure that indexes the data to enable subsequent searching and retrieval of specifical data as required.

FIG. 4 also shows an interactive map in interface (210) which may be presented to user (60) to enable the user (60) to easily identify and select a location (90) (i.e. the location (90) of the equipment (85) which they are listing as available for borrowing or hiring).

FIG. 5 shows in greater detail the various components depicted in segment 500 of FIG. 1 and, in particular, an example interface (220) which displays search results after a search request has been submitted by a user (30), wherein the displayed equipment (85) represents a subset of all of the available equipment listed by registered users (60). In other words, the listing (220) in FIG. 5 represents a list generated by search engine (140) after processing the data submitted by the users (30) seeking equipment, as well as the users (60) seeking to loan or hire out the equipment, and short-listing a subset of equipment (85) for selection by user (30). By utilizing a key word search algorithm incorporated with a geographical restriction, the search facility generates results that have been automatically filtered according to equipment available within a pre-determined vicinity of a registered location (80) of the potential borrower or hirer (30), eg within X km which vicinity may be specified by the potential borrower or hirer (30) through the software application (40).

The results displayed in interface (220) may further be filtered or sorted according to any filtering or sorting criteria preferred by the user (30), including by equipment characteristics, hiring costs etc.

The description (95) relating to each equipment as provided in interface (220) may include details such as a hiring rates which have been set by users (60), including different rates which apply for particular days of the week, or for different periods of time, as well as any penalty costs that may be applicable in respect of failure to return equipment in acceptable condition or within the terms of the borrowing or hiring arrangement. In another example, there may be individual rates set by users (60) in respect of commercial or residential arrangements in order to cater for different uses of equipment (85) and, in particular, different levels of likely wear and tear. In other words, where there is potential for increased degradation or damage of equipment (e.g. in commercial settings) an increased hire rate may apply.

Once a particular piece of equipment (85) has been selected by the user (30), the user (30) may be prompted to specify whether the arrangement is a borrowing or hiring arrangement, and a time period for which the arrangement applies. In this regard, the calendar functionality (120) may be operable to provide a graphical representation of a calendar to the user (30) that allows the user (30) to select available dates for the borrowing or hiring of particular equipment (85). Further, more additional information may be provided to the user (30) based upon selection of a particular piece of equipment, including instructional material to assist the user (30) regarding correct operation of the equipment (85) (eg. instructional manuals and media including photos, videos etc.).

A communication gateway may also be provided between users (30) and users (60) that allows for communication between the users including to facilitate establishing a borrowing or hiring arrangement, e.g. chat functionality that enables the exchange of messages regarding the status and/or availability of equipment, and the terms upon which the equipment will be borrowed or hired.

FIG. 6 shows in greater detail the various components depicted in Segment 600 of FIG. 1 and, in particular, interfaces (230) and (240) which provide the respective users (30) and (60) with an indication regarding whether particular equipment and/or users have satisfied minimum verification thresholds. For example, from the perspective of users (30), interface (230) may confirm that the description relating to equipment (85) provided by a user (60) is reliable by comparing same against a database of existing equipment details to determine any errors which may exist in respect of the description (95) relating to the equipment (85). In another example, the equipment (85) may be verified by comparing an identifier associated with the equipment (e.g. serial number) with a database of registered serial numbers associated with the particular make and/or model of the equipment (85).

Any images of the equipment provided by user (60) may also be verified as being a recently captured image by, for example, comparing a date and time stamp of the image with a current date and time. This may also facilitate the verification of the equipment by utilizing one or more artificial intelligence techniques to compare the description regarding the condition of the equipment with the verified image of the equipment. In this regard, if the description indicates “excellent condition” yet the recently captured photo of the image appears to include indicators that suggest otherwise, then a verification alert may be generated that suggests to user (30) that the description regarding the condition of the equipment may not be accurate. In this example, the “indicators” may be determined by utilizing visual comparison techniques to compare the image of the used equipment against one or more images of the same equipment in a new state such that any differences may be identified and brought to the attention of user (30).

From the perspective of users (60) who are allowing users (30) to borrow or hire their equipment (85), interface (240) may provide an indication to users (60) that a potential borrower or hirer (30) of their equipment fails to satisfy minimum security authentication requirements (eg. through the checking of police records associated with the user (30) or any other similar public record that may be relevant for the purpose of verifying the suitability of the user (30) for borrowing or hiring of equipment (85)). In this regard, the borrower or hirer (30) may be prompted, in interface (190), to provide a minimum amount of identification including the provision of a driver's license or passport in respect of which the details may be used to consult third party databases for the purpose of verification.

FIG. 7 shows in greater detail the various components depicted in Segment 700 of FIG. 1 and, in particular, interfaces (250) and (260) that are available to all users for the purpose of interacting with a particular insurance provider (98) after selecting the particular insurance provider (98) from a list of insurance providers presented to the uses in interface (220). From the perspective of user (30), the user (30) is provided with data communication links to one or more insurance providers in interface (220) following the selection of a particular equipment for borrow or hire. The user (30) may select one of the insurance provider links and engage with the selected insurance provider to seek cover with respect to the loan and/or hire of equipment, as described above. From the perspective of user (60), interface (200) may present a similar listing of available insurance providers to user (60). By providing such links, the users (30) and (60) may quickly and seamlessly seek and obtain cover that is relevant to their individual circumstances and which may be tailored to the particular user and/or the particular equipment sought to be borrowed or hired.

For example, the user (30) may seek insurance cover against any damage or failure regarding proper operation of a piece of equipment, whereas the user (60) may seek cover against stolen equipment or the return of equipment in a degraded or damaged condition. Whilst an insurance provider (98) with whom users (30) and/or (60) may interact and engage is shown in FIG. 7, it will be understood that the obtaining of insurance cover may be completed through the generation of an online form or insurance survey questions that are automatically generated for completion by users. For example, a database of forms and/or surveys may exist from which a relevant form/survey may be automatically selected based upon the data submitted and/or the equipment selected.

Interface (250) provides an example interface that enables the users (30) and (60) to provide a premium payment to the insurance provider with respect to any agreed cover, whilst interface (260) represents an example interface that enables communications with the insurance provider (eg. via a live bot, live chat etc.). The payment functionality is provided through payment gateway (160) associated with server (20) which also manages fund transfers between relevant financial institutions associated with users (30) and (60), eg for equipment hire, and with respect to any subscription fees that are payable to the platform administration.

FIG. 8 shows in greater detail the various components depicted in Segment 800 of FIG. 1 and, in particular, an interface (270) associated with software applications (40) and (70) for providing alerts and/or notifications to each respective group of users (30) and (60) (eg. where a user (30) is seeking to borrow or hire a particular piece of equipment (85) which is not currently available but which may become available in future once the equipment has been returned). In this regard, an example of an alert or a notification that may be sent to the user (30) is a notification that the piece of equipment (85) is now available. Such alerts and/or notifications may be sent via push notification, text message or any other means.

In another example, the verification of certain users and/or equipment may not be available at the time of seeking verification, and therefore an alert and/or notification may also be provided to users when such verification information becomes available. Alerts and/or notifications may also generate based upon the transmittal of communications between users, and between users and insurance providers, eg. messages between users or messages between users and insurance providers.

Additional interfaces may very well be generated using software applications (40) and (70) which are not described herein for the purpose of brevity, including for example interfaces which may enable users (30) and (60) to update settings, preferences and any submitted details after a user and/or equipment profile has been created.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method of facilitating the borrowing or hiring of equipment, the method comprising:
receiving, by one or more processors, details relating to one or more potential borrowers or hirers of equipment, the details comprising at least a location of each of the one or more potential borrowers or hirers;
receiving, by one or more processors, details regarding each piece of equipment available for loan or hire, the details comprising:
information relating to the entity responsible for providing the piece of equipment for loan or hire comprising a pickup location of the piece of equipment,
a description relating to the piece of equipment comprising a description regarding the condition of the piece of equipment, and
an image of the piece of equipment;
verifying, by one or more processors, the details regarding each piece of equipment available for loan or hire by verifying the description regarding the condition of the equipment, comprising verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image against one or more images of the equipment in a new state;
storing, by one or more processors, the verified equipment details in an equipment database comprising a data structure that identifies relationships between each piece of equipment and stored details relating to same;
providing, by one or more processors, a search facility that enables a potential borrower or hirer to utilize a data communications device to search the data structure for a piece of equipment using a key word search, the search facility utilizing a key word search algorithm incorporated with a geographical restriction such that any search request submitted by a potential borrower or hirer generates results retrieved using the data structure and filtered according to the pickup location of the piece of equipment residing within a predetermined vicinity of the location of the potential borrower or hirer; and
providing, by one or more processors, an interactive interface that enables:
the potential borrower or hirer to view the verified details regarding equipment selected by the potential borrower or hirer from the generated search results,
the potential borrower or hirer to confirm their selection of the equipment to borrow or hire and thereby establish a borrowing or hiring arrangement with the entity responsible for providing the piece of equipment, and
the potential borrower or hirer and/or the entity responsible for providing the equipment for loan or hire to access data communication links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

2. The computer implemented method according to claim 1, wherein the method further includes comprises utilizing a central server to communicate with data communication devices associated with each of the potential borrower or hirer and each of the entities responsible for providing the equipment for loan or hire, whereby each device is operable to execute a software application that enables communication with the central server.

3. The computer implemented method of claim 1, wherein the location of the potential borrower or hirer is a registered address of the potential borrower or hirer, a current location of the potential borrower or hirer, or a preferred address of the potential borrower or hirer.

4. A-The computer implemented method according of claim 3, wherein the current location of the potential borrower or hirer is determined in substantially realtime by utilizing one or more of:
GPS functionality,
Wi-Fi functionality,
Cell ID, and/or
A-GPS (Assisted GPS) functionality.

5. The computer-implemented method of claim 1, wherein the details regarding each piece of equipment further comprises one or more of:
an identifier associated with the equipment, and
a make and/or model of the equipment.

6. The computer-implemented method of claim 1, wherein the description relating to each piece of equipment further comprises one or more of:
a hiring rate set by the user responsible for providing the equipment for hire, comprising a different hiring rate based on different periods of time for which the equipment will be hired, and
penalty costs applicable in respect of failure to return equipment either in acceptable condition or within terms of the borrowing or hiring arrangement.

7. The computer implemented method of claim 6, wherein the piece of equipment is categorized according to its attributes and/or use and the hiring rate is based upon the categorization of the equipment.

8. The computer implemented method of claim 7, wherein the use of a piece of equipment is categorized as either residential or commercial, and different hiring rates apply in respect of commercial and residential arrangements based on the different uses of the equipment.

9. The computer-implemented method of claim 5, wherein verifying, by one or more processors, details regarding each piece of equipment further comprises verifying one or more of the following:
the description relating to the equipment by comparing the description against a database of existing equipment to determine any errors or inaccuracies with respect to the description, or
the identifier associated with the equipment by comparing the identifier with a database of registered serial numbers associated with a particular make and/or model of the equipment,

10. The computer implemented method of claim 1, wherein the details relating to one or more potential borrowers or hirers of equipment comprises a minimum amount of identification requested at the time the borrower or hirer establishes a user account.

11. The computer implemented method of claim 10, wherein the minimum amount of identification comprises a driver's license and/or passport of the borrower or hirer.

12. The computer-implemented method of 10, further comprising:
conducting, by one or more processors, one or more security analyses regarding each potential borrower or hirer, comprising, an analysis at the time the borrower or hirer seeks to establish the user account and at one or more intervals thereafter.

13. The computer-implemented method of claim 12, wherein the security analyses comprise checking, by one or more processors, the existence of a police record associated with the potential borrower or hirer.

14. The computer-implemented method of claim 1, wherein the interactive interface further enables one or more of:
a calendar functionality that allows potential borrowers or hirers to select available dates for the borrowing or hiring of a particular piece of equipment,
a payment gateway that allows potential hirers to make a payment in relation to hiring a selected equipment for a selected period of time,
provision of instructional material comprising documents and media to assist the borrower or hirer regarding correct operation of the piece of equipment, or
a communication gateway that allows for communication between users seeking to establish a borrowing or hiring arrangement.

15. A system that facilitates the borrowing or hiring of equipment, the system comprising one or more processors that:
receive details relating to one or more potential borrowers or hirers of equipment, the details comprising at least a location of each of the one or more potential borrowers or hirers;
receive details regarding each piece of equipment available for loan or hire, the details comprising:
information relating to the entity responsible for providing the piece of equipment for loan or hire comprising a pickup location of the piece of equipment, a description relating to the piece of equipment comprising a description regarding the condition of the piece of equipment, and
an image of the piece of equipment;
verify, by one or more processors, the details regarding each piece of equipment available for loan or hire by verifying the description regarding the condition of the equipment, comprising verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image against one or more images of the equipment in a new state;
store the verified equipment details in an equipment database that includes comprises a data structure that identifies relationships between each piece of equipment and stored details relating to same;
provide a search facility enabling a potential borrower or hirer to utilize a data communications device to search the data structure for a piece of equipment using a key word search, the search facility utilizing a key word search algorithm incorporated with a geographical restriction such that any search request submitted by a potential borrower or hirer generates results retrieved using the data structure and filtered according to the pickup location of the piece of equipment residing within a predetermined vicinity of the registered location of the potential borrower or hirer,
provide an interactive interface that enables:
the potential borrower or hirer to view the verified details regarding equipment selected by the potential borrower or hirer from the generated search results,
the potential borrower or hirer to confirm their selection of the equipment to borrow or hire and thereby establish a borrowing or hiring arrangement with the entity responsible for providing the piece of equipment, and
the potential borrower or hirer and/or the entity responsible for providing the equipment for loan or hire to access data communication links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

16. A non-transient computer-readable medium comprising computer instruction code that, when executed on a computer, causes one or more computer processors of the computer to perform steps to facilitate the borrowing or hiring of equipment, comprising:
receiving details relating to one or more potential borrowers or hirers of equipment, the details comprising at least a location of each of the one or more potential borrowers or hirers;
receiving details regarding each piece of equipment available for loan or hire, the details comprising:
information relating to the entity responsible for providing the piece of equipment for loan or hire comprising a pickup location of the piece of equipment,
a description relating to the piece of equipment comprising a description regarding the condition of the piece of equipment, and
an image of the piece of equipment;
verifying, by one or more processors, the details regarding each piece of equipment available for loan or hire by verifying the description regarding the condition of the equipment, comprising verifying that the image of the equipment is a recently captured image by comparing a date and time stamp of the image with a current date and time, and utilizing one or more artificial intelligence techniques to compare the description regarding the condition of the equipment with condition indicators obtained from the verified image of the equipment and wherein the condition indicators are determined by utilizing one or more visual comparison techniques to compare the verified image against one or more images of the equipment in a new state;
storing the verified equipment details in an equipment database that comprises a data structure that identifies relationships between each piece of equipment and stored details relating to same;
providing a search facility enabling a potential borrower or hirer to utilize a data communications device to search the data structure for a piece of equipment using a key word search, the search facility utilizing a key word search algorithm incorporated with a geographical restriction such that any search request submitted by a potential borrower or hirer generates results retrieved using the data structure and filtered according to the pickup location of the piece of equipment residing within a predetermined vicinity of the registered location of the potential borrower or hirer,
providing an interactive interface that enables:
the potential borrower or hirer to view the verified details regarding equipment selected by the potential borrower or hirer from the generated search results,
the potential borrower or hirer to confirm their selection of the equipment to borrow or hire and thereby establish a borrowing or hiring arrangement with the entity responsible for providing the piece of equipment, and
the potential borrower or hirer and/or the entity responsible for providing the equipment for loan or hire to access data communication links with one or more insurance providers to enable a selected insurance provider to access verified equipment details relating to equipment included in the borrowing or hiring arrangement and to enable the potential borrower or hirer and/or the entity responsible for providing the equipment for loan or hire to obtain insurance cover with respect to the borrowing or hiring arrangement.

17. (canceled)
